(19) United States
(12) Patent Application Publication
(10) Pub. No.: US 2022/0383481 A1
(43) Pub. Date: Dec. 1, 2022

(54) APPARATUS FOR DEEP FAKE IMAGE DISCRIMINATION AND LEARNING METHOD THEREOF

(71) Applicants: SAMSUNG SDS CO., LTD., Seoul (KR); CHUNG ANG University industry Academic Cooperation Foundation, Seoul (KR)

(72) Inventors: Do-Yeon KIM, Seoul (KR); Jong-Won CHOI, Seoul (KR); Pyoung-Geon KIM, Seoul (KR); Yong-Hyun JEONG, Seoul (KR); Young-Min RO, Seoul (KR)

(21) Appl. No.: 17/824,158

(22) Filed: May 25, 2022

(30) Foreign Application Priority Data
May 25, 2021 (KR) 10-2021-0067026

(51) Int. Cl. G06T 7/00; G06N 3/08; G06N 3/04

(52) U.S. Cl. CPC G06T 7/0002; G06N 3/08; G06N 3/0454; G06T 2207/20084; G06T 2207/20081

(57) ABSTRACT

An apparatus for deep fake image discrimination according to an embodiment includes an interface unit configured to receive image data and a classifier configured to determine whether the image data input through the interface unit is a deep fake image, and the classifier is trained to determine a deep fake image based on a synthetic image generated by swapping a portion of a real image with a fake image generated by self-replicating the real image.

### CROSS-REFERENCE TO RELATED APPLICATION(S) AND CLAIM OF PRIORITY

This application claims the benefit under 35 USC § 119 of Korean Patent Application No. 10-2021-0067026, filed on May 25, 2021, in the Korean Intellectual Property Office, the entire disclosure of which is incorporated herein by reference for all purposes.

### BACKGROUND

### 1. Field

Embodiments disclosed herein relate to a technology for discriminating a deep fake image.

### 2. Description of Related Art

A In general, the deep fake detection model in the related art is overfitted to training data and highly dependent, and thus has a ‘generalization problem’ in which the detection rate is greatly reduced when a test is performed with non-training data. To solve the above-mentioned problem, the deep fake detection model may be trained with fake images of various GAN models, object categories, and image manipulation types, but the method takes a lot of time and cost.

Examples of the related art include Korean Patent Laid-Open Publication No. 10-2021-0049570 (published on May 6, 2021).

### SUMMARY

The disclosed embodiments are intended to provide an apparatus for deep fake image discrimination and a learning method therefor.

In one general aspect, there is provided an apparatus for deep fake image discrimination including: an interface unit configured to receive image data; and a classifier configured to determine whether the image data input through the interface unit is a deep fake image, in which the classifier is trained to determine a deep fake image based on a synthetic image generated by swapping a portion of a real image with a fake image generated by self-replicating the real image.

The classifier may be trained based on the synthetic image received through a gradient reversal layer.

The fake image may be generated through an autoencoder trained to generate a fake image by self-replicating a real image, and the synthetic image may be generated through an adaptive augmenter configured to generate a synthetic image by swapping a portion of the real image with the fake image based on a predetermined parameter.

The autoencoder may receive a reversed gradient from the gradient reversal layer, and be updated in a direction in which it is difficult for the classifier to determine a deep fake image.

The predetermined parameter may be composed of a combination of set values for at least one of a size, shape, number, and position of a mask for masking a portion of an image to be swapped.

The classifier may be configured to calculate a confidence score for each of one or more synthetic images generated according to one or more predetermined parameters having different set values and transmit the calculated confidence score to the adaptive augmenter, and the adaptive augmenter may be configured to decide a frequency of application of each of the one or more predetermined parameters based on the confidence score.

The frequency of application of each of the one or more predetermined parameters may be decided in reverse proportion to the confidence score.

In another general aspect, there is provided a method for training a classifier included in an apparatus for deep fake image discrimination, the method including: generating a fake image by self-replicating a real image; generating a synthetic image by swapping a portion of the real image with the fake image; and learning the classifier to determine a deep fake image based on the synthetic image.

### BRIEF DESCRIPTION OF THE DRAWINGS

FIG. 1 is a block diagram of an apparatus for deep fake image discrimination according to an embodiment.

FIG. 2 is a structural diagram of a learning framework of an apparatus for deep fake image discrimination according to an embodiment.

FIG. 3 is a flowchart of a learning method for an apparatus for deep fake image discrimination according to an embodiment.

FIG. 4 is a flowchart of a learning method for an apparatus for deep fake image discrimination according to an embodiment.

FIG. 5 is a block diagram for exemplarily illustrating a computing environment including a computing device according to an embodiment.

### DETAILED DESCRIPTION

Hereinafter, specific embodiments of the present disclosure will be described with reference to the accompanying drawings. The following detailed description is provided to assist in a comprehensive understanding of the methods, devices and/or systems described herein. However, the detailed description is only for illustrative purposes and the present disclosure is not limited thereto.

In describing the embodiments of the present disclosure, when it is determined that detailed descriptions of known technology related to the present disclosure may unnecessarily obscure the gist of the present disclosure, the detailed descriptions thereof will be omitted. The terms used below are defined in consideration of functions in the present disclosure, but may be changed depending on the customary practice or the intention of a user or operator. Thus, the definitions should be determined based on the overall content of the present specification. The terms used herein are only for describing the embodiments of the present disclosure, and should not be construed as limitative. Unless expressly used otherwise, a singular form includes a plural form. In the present description, the terms “including”, “comprising”, “having”, and the like are used to indicate certain characteristics, numbers, steps, operations, elements, and a portion or combination thereof, but should not be interpreted to preclude one or more other characteristics, numbers, steps, operations, elements, and a portion or combination thereof.

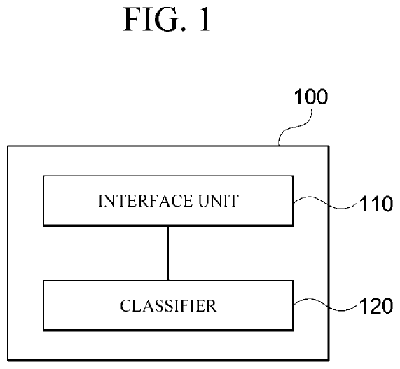

FIG. 1 is a block diagram of an apparatus for deep fake image discrimination according to an embodiment.

According to an embodiment, an apparatus for deep fake image discrimination (deep fake image discrimination apparatus) 100 may include an interface unit 110 to which image data is input and a classifier 120 that determines whether the image data input through the interface unit 110 is a deep fake image.

According to an example, the classifier 120 is a classifier capable of distinguishing a fake image from a real image, and may output a confidence score for a detection result.

According to an embodiment, the fake image may be generated through an autoencoder trained to generate a fake image by self-replicating a real image.

According to an example, the autoencoder may learn only the real image, unlike the existing GAN model that uses both a ‘real image’ obtained by photographing a real subject and a ‘fake image’ generated with a generative model for learning, and may self-replicate the learned real image to generate a fake image with high similarity to the real image. This allows the autoencoder to generate as many fake images as the number of real images.

According to an example, the autoencoder may identify the rule of a fake image with a deep fake difficult to detect and automatically generate a necessary image. The autoencoder may generate a high-difficulty-level fake image by receiving a reversed gradient from a gradient reversal layer, and may improve the performance of the classifier 120 by further training the classifier 120 using the generated high-level fake image.

According to an embodiment, the classifier 120 may be trained to determine a deep fake image based on a synthetic image generated by swapping a portion of the real image with the fake image generated by self-replicating the real image.

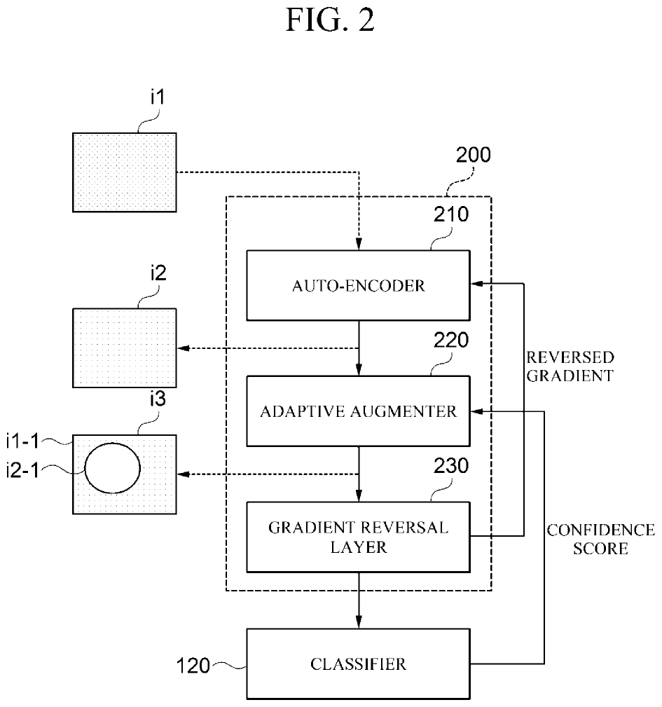

FIG. 2 is a structural diagram of a learning framework of a deep fake image discrimination apparatus according to an embodiment.

According to an example, a learning framework 200 may be designed to utilize increasingly difficult data augmentation as training data by being trained to apply data augmentation techniques focusing on rules that are difficult for the classifier 120 to discriminate. In addition, the learning framework 200 may be trained to perform data augmentation focusing on a specific data augmentation technique and characteristic when the confidence score of the classifier 120 is confirmed to be low in the technique and characteristic.

Referring to FIG. 2, an autoencoder 210 may receive a real image i1 and generate a fake image i2 by self-replicating the input real image.

According to an example, the self-replicated image does not have a distribution of a specific GAN model or object category, and may have only the most general characteristics of a fake image. Accordingly, when the classifier 120 is trained based on the self-replicated image, it is possible to improve the general detection performance by reducing the dependence on a specific distribution.

As one example, when one GAN model generates multiple object category images, artifacts with different characteristics are generated for each object category, which may lead to model dependence on training data. In addition, when the generation range of the GAN model is extended and a new object category appears, a new model has to be trained anew every time, and thus it takes a lot of time and cost to be trained when the training range is expanded according to the new GAN model.

According to an embodiment, the autoencoder 210 may receive a reversed gradient from a gradient reversal layer 230, and be updated in a direction in which it is difficult for the classifier 120 to determine a deep fake image.

As one example, the gradient reversal layer 230 is a layer that reverses the direction of a gradient when a gradient descent algorithm essentially utilized in the process of learning a neural network is applied.

According to an example, if the classifier 120 is continuously trained using the autoencoder 210 that simply generates a fake image, the classifier 120 is trained focusing on a specific artifact output by the autoencoder 210, and thus may be easily overfitted. Accordingly, by disposing the gradient reversal layer 230 in front of the classifier 120, the autoencoder 210 may be trained in a direction (reversal) in which the classifier 120 is not capable of further distinguishing a fake image.

As one example, in order to improve the performance of the classifier 120, the neural network in front of the gradient reversal layer 230 is trained so that the performance of the classifier 120 decreases. Based on the operation, the autoencoder 210 is trained in a direction of degrading the performance of the classifier 120. That is, the autoencoder 210 is updated to generate a fake image focusing on samples that the classifier 120 is more difficult to find out.

According to an embodiment, the classifier 120 may receive a synthetic image through the gradient reversal layer 230, and may be trained based on the received synthetic image.

According to an example, the autoencoder 210 may classify the fake image into hard-negative and easy-negative for each category for learning, and may be fine-tuned to generate a fake image focusing on a more difficult hard-negative image. In addition, it is possible for the classifier 120 to improve the dependence on the object category by being trained based on the fake image generated by the fine-tuned autoencoder 210, and thus, it is possible for the classifier 120 to detect an image that has never been touched in a learning stage.

According to an embodiment, the synthetic image may be generated through an adaptive augmenter 220 that generates a synthetic image by swapping a portion of the real image with the fake image based on a predetermined parameter.

As one example, the adaptive augmenter 220 is a module that mixes a fake image with a real image to generate a synthetic image. As one example, the adaptive augmenter 220 does not simply randomly mix the real image and the fake image, but rather may adjust a difficulty level such that the classifier 120 performs the mixing more frequently in a direction in which the classifier 120 does not further distinguish the synthetic image based on the confidence score of the classifier 120 for the synthetic image that has been differently generated according to the mixing method.

As one example, when the classifier 120 is trained only by a fully manipulated image, the classifier 120 is trained to pay attention to the entire photograph, and as a consequence, the classifier 120 may not detect a partially manipulated image. Accordingly, in order to improve the dependence on the partial manipulation type, the classifier 120 according to an embodiment may be trained using at least one of the fully manipulated image and the partially manipulated image. For example, the fully manipulated image may be a fake image generated through the autoencoder 210, and the partially manipulated image may be a synthetic image generated by partially combining the real image and the duplicated fake image in the adaptive augmenter 220.

As one example, the adaptive augmenter 220 may generate a synthetic image i3 by swapping a portion of a real image i1-1 with a fake image i2-1. In this case, the portion of the fake image i2-1 that is swapped and inserted may be an image at a position corresponding to the portion of the real image i1-1 that is swapped and removed.

Referring to FIG. 2, the synthetic image i3 may be generated by cropping a replicated fake image i2 and then combining it with the real image i1, and the fake image i2 may be very similar to the real image i1 and thus the boundary line thereof may be naturally blended. Accordingly, the adaptive augmenter 220 may generate a synthetic image having a higher detection difficulty level than the existing face swap method that leaves a rough boundary line.

According to an embodiment, the predetermined parameter may be composed of a combination of set values for at least one of a size, shape, number, and position of a mask for masking a portion of an image to be swapped.

According to an example, the predetermined parameter may be a set value for the size of the mask. For example, the size of the mask may be the width of the mask, and the set value may have a value such as 1 cm², 1.5 cm², 2 cm², and the like.

According to an example, the predetermined parameter may be a set value for the shape of the mask. For example, the shape of the mask may be a rectangle, a triangle, a circle, or the like, and each set value may be a predetermined number matching the mask shape, such as 1, 2, or 3.

According to an example, the predetermined parameter may be a set value for the number of masks. For example, the number of masks may be one, two, three, or the like, and the set value may be set to 1, 2, 3, or the like.

According to an example, the predetermined parameter may be a set value for the mask position. For example, the mask position may be indicated by values of the x-axis and y-axis of the image, and may be set as (1, 1), (1, 2), and the like.

According to an example, the predetermined parameter may be a combination of set values for at least one of the size, shape, number, and position of the mask. For example, when the predetermined parameter is composed of the size and number of masks, the predetermined parameter may be configured as (size, number). For example, when the size=1 and the number=2, the predetermined parameter may have a set value such as (1, 2).

According to an embodiment, the classifier 120 may calculate a confidence score for each of one or more synthetic images generated according to one or more predetermined parameters having different set values and transmit the calculated confidence score to the adaptive augmenter 220.

As one example, the adaptive augmenter 220 may generate a new synthetic image by randomly selecting several parameters capable of controlling a mixing method for two images to mix the real image and the fake image. However, when the classifier 120 is sufficiently trained, the classifier 120 may easily find out some combinations of numerous parameter combinations, but the classifier 120 may not easily recognize specific combinations.

According to an embodiment, the adaptive augmenter 220 may decide the frequency of application of each of one or more predetermined parameters based on the confidence score. As one example, the classifier 120 may calculate a confidence score ClassifierScore(X) for several combinations of parameters, and may calculate a reciprocal value as an augment score as shown in Equation 1 below based on the confidence score.

$$AugmentScore ( θ ) = {\sum }_{x} exp ( - ClassifierScore ( A ( X , θ ) ) ) \qquad [ Equation 1 ]$$

Here, θ is a specific parameter for data augmentation, and A(X, θ) is a function for outputting data augmented based on the augmentation parameter of θ when data X is input.

According to an embodiment, the frequency of application of each of one or more predetermined parameters may be decided in reverse proportion to the confidence score. For example, in the case of using Equation 1 above, the design is made so that data augmentation parameter becomes smaller as the confidence score calculated by the classifier 120 increases, and accordingly, the adaptive augmenter 220 may be updated to frequently select more difficult data augmentation methods than easy data augmentation methods.

According to an embodiment, the adaptive augmenter 220 may be updated based on the confidence score to use only predetermined parameters with confidence score that is less than or equal to a predetermined value.

According to an example, the autoencoder 210 and the adaptive augmenter 220 may be updated to generate images for which the currently trained classifier 120 does not discriminate a deep fake image well and attempt data augmentation focusing on more difficult data augmentation methods. Accordingly, the classifier 120 may utilize the newly generated data using the updated autoencoder 210 and adaptive augmenter 220 as training data, through which additional training may be performed.

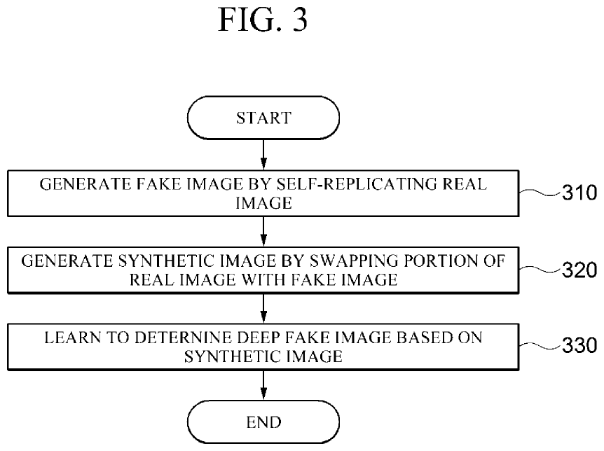

FIG. 3 is a flowchart of a learning method for a deep fake image discrimination apparatus according to an embodiment.

According to an embodiment, the deep fake image discrimination apparatus may include a classifier for discriminating a deep fake image. According to an example, the classifier is a classifier capable of distinguishing a fake image from a real image, and may output a confidence score for a detection result.

The learning method according to an embodiment may include generating a fake image by self-replicating a real image (310). As one example, the fake image may be generated through an autoencoder trained to generate a fake image by self-replicating a real image. For example, the autoencoder may learn only the real image, unlike the existing GAN model which uses both a ‘real image’ obtained by photographing a real subject and a ‘fake image’ generated with a generative model for learning, and may self-replicate the learned real image to generate a fake image with high similarity to the real image.

According to an embodiment, the autoencoder may receive a reversed gradient from a gradient reversal layer, and be updated in a direction in which it is difficult for the classifier to determine a deep fake image.

According to an example, the autoencoder may identify the rule of a fake image with a deep fake difficult to detect and automatically generate a necessary image. The autoencoder may generate a high-difficulty-level fake image by receiving the reversed gradient from the gradient reversal layer, and may improve the performance of the classifier by further training the classifier using the generated high-difficulty-level fake image.

The learning method according to an embodiment may include generating a synthetic image by swapping a portion of the real image with the fake image (320).

According to an embodiment, the classifier may be trained to determine a deep fake image based on the synthetic image generated by swapping a portion of the real image with the fake image generated by self-replicating the real image.

According to an embodiment, the synthetic image may be generated through an adaptive augmenter that generates a synthetic image by swapping a portion of the real image with the fake image based on a predetermined parameter.

As one example, the adaptive augmenter may generate a synthetic image by swapping a portion of the real image with the fake image. In this case, the portion of the fake image that is swapped and inserted may be an image at a position corresponding to the portion of the real image that is swapped and removed.

According to an embodiment, the predetermined parameter may be composed of a combination of set values for at least one of a size, shape, number, and position of a mask for masking a portion of an image to be swapped.

As one example, the adaptive augmenter may generate a new synthetic image by randomly selecting several parameters capable of controlling a mixing method for two images to mix the real image and the fake image. However, when the classifier is sufficiently trained, the classifier may easily find out some combinations of numerous parameter combinations, but the classifier may not easily recognize specific combinations.

According to an embodiment, the adaptive augmenter may decide the frequency of application of each of one or more predetermined parameters based on a confidence score.

According to an embodiment, the frequency of application of each of one or more predetermined parameters may be decided in reverse proportion to the confidence score.

According to an embodiment, the adaptive augmenter may be updated based on the confidence score to use only predetermined parameters with confidence score that is less than or equal to a predetermined value.

The learning method according to an embodiment may include learning to determine a deep fake image based on the synthetic image (330).

According to an example, the autoencoder and the adaptive augmenter may be updated to generate images for which the currently trained classifier does not discriminate a deep fake image well and attempt data augmentation focusing on more difficult data augmentation methods. Accordingly, the classifier may utilize the newly generated data using the updated autoencoder and adaptive augmenter as training data, through which additional training may be performed.

In the learning method according to an embodiment, description overlapping with those described with reference to FIGS. 1 and 2 will be omitted.

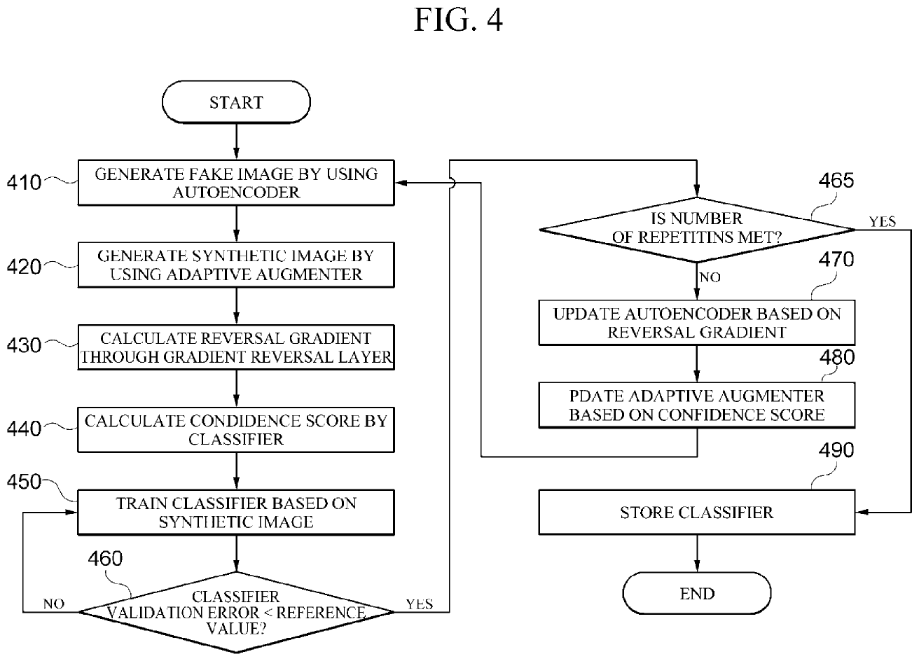

FIG. 4 is a flowchart of a learning method for a deep fake image discrimination apparatus according to an embodiment.

According to an embodiment, a fake image may be generated by using an autoencoder to generate training data for training the deep fake image discrimination apparatus (410). Then, an adaptive augmenter may generate a synthetic image by using a real image and a fake image (420).

According to an embodiment, in the generated synthetic image, a reversal gradient may be calculated through a gradient reversal layer located in front of the classifier (430).

According to an embodiment, the synthetic image may be input to the classifier, and the classifier may determine whether the input synthetic image is a deep fake image, and may calculate a confidence score for the determined result (440). Further, the classifier may perform learning by using the synthetic image (450). In this case, a classifier validation error may be checked, and the classifier may perform learning until the error becomes less than or equal to a predetermined reference value (460).

According to an embodiment, the autoencoder and adaptive augmenter may be updated based on the previously calculated reversal gradient and confidence score (470, 480). Then, the updated autoencoder and adaptive augmenter may regenerate the fake image and the synthetic image, and may train the classifier based on the regenerated synthetic image.

According to an embodiment, the above process may be repeated up to a predetermined number of repetitions (465), and when the learning process is repeated for the predetermined number of repetitions, the classifier that has completed learning may be stored (490).

In the learning method according to an embodiment, content overlapping with those described with reference to FIGS. 1 to 3 will be omitted.

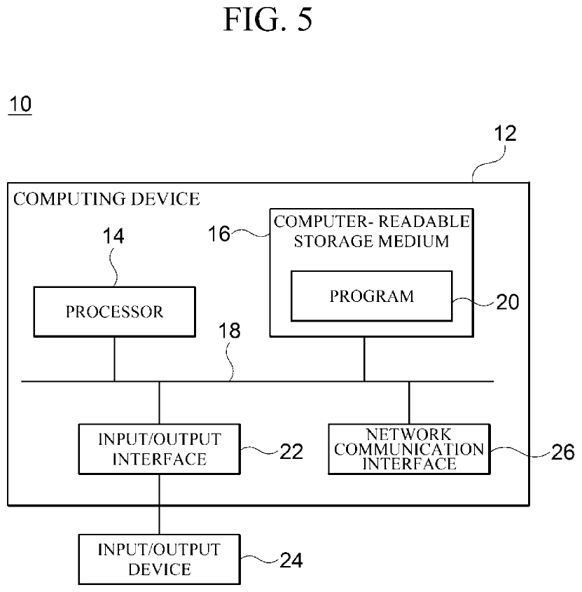

FIG. 5 is a block diagram for exemplarily illustrating a computing environment including a computing device according to an embodiment.

In the illustrated embodiments, each component may have different functions and capabilities in addition to those described below, and additional components may be included in addition to those described below.

The illustrated computing environment 10 includes a computing device 12. In an embodiment, the computing device 12 may be one or more components included in the deep fake image discrimination apparatus 100. The computing device 12 includes at least one processor 14, a computer-readable storage medium 16, and a communication bus 18. The processor 14 may cause the computing device 12 to operate according to the above-described exemplary embodiments. For example, the processor 14 may execute one or more programs stored in the computer-readable storage medium 16. The one or more programs may include one or more computer-executable instructions, which may be configured to cause, when executed by the processor 14, the computing device 12 to perform operations according to the exemplary embodiments.

The computer-readable storage medium 16 is configured to store computer-executable instructions or program codes, program data, and/or other suitable forms of information. A program 20 stored in the computer-readable storage medium 16 includes a set of instructions executable by the processor 14. In an embodiment, the computer-readable storage medium 16 may be a memory (a volatile memory such as a random-access memory, a non-volatile memory, or any suitable combination thereof), one or more magnetic disk storage devices, optical disc storage devices, flash memory devices, other types of storage media that are accessible by the computing device 12 and may store desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 via the input/output interface 22. The exemplary input/output device 24 may include a pointing device (a mouse, a trackpad, or the like), a keyboard, a touch input device (a touch pad, a touch screen, or the like), a voice or sound input device, input devices such as various types of sensor devices and/or imaging devices, and/or output devices such as a display device, a printer, an interlocutor, and/or a network card. The exemplary input/output device 24 may be included inside the computing device 12 as a component constituting the computing device 12, or may be connected to the computing device 12 as a separate device distinct from the computing device 12.

According to the embodiments disclosed herein, it is possible to secure an apparatus for deep fake image discrimination having a lower dependence on training data and having general-purpose detection performance.

Although the present disclosure has been described in detail through the representative embodiments as above, those skilled in the art will understand that various modifications can be made thereto without departing from the scope of the present disclosure. Therefore, the scope of rights of the present disclosure should not be limited to the described embodiments, but should be defined not only by the claims set forth below but also by equivalents of the claims.

What is claimed is:

1. An apparatus for deep fake image discrimination, the apparatus comprising:
an interface unit configured to receive image data; and
a classifier configured to determine whether the image data input through the interface unit is a deep fake image,
wherein the classifier is trained to determine a deep fake image based on a synthetic image generated by swapping a portion of a real image with a fake image generated by self-replicating the real image.

2. The apparatus of claim 1, wherein the classifier is trained based on the synthetic image received through a gradient reversal layer.

3. The apparatus of claim 2, wherein the fake image is generated through an autoencoder trained to generate a fake image by self-replicating a real image; and
the synthetic image is generated through an adaptive augmenter configured to generate a synthetic image by swapping a portion of the real image with the fake image based on a predetermined parameter.

4. The apparatus of claim 3, wherein the autoencoder receives a reversed gradient from the gradient reversal layer, and is updated in a direction in which it is difficult for the classifier to determine a deep fake image.

5. The apparatus of claim 3, wherein the predetermined parameter is composed of a combination of set values for at least one of a size, shape, number, and position of a mask for masking a portion of an image to be swapped.

6. The apparatus of claim 5, wherein the classifier is configured to calculate a confidence score for each of one or more synthetic images generated according to one or more predetermined parameters having different set values and transmits the calculated confidence score to the adaptive augmenter, and the adaptive augmenter is configured to decide a frequency of application of each of the one or more predetermined parameters based on the confidence score.

7. The apparatus of claim 6, wherein the frequency of application of each of the one or more predetermined parameters is decided in reverse proportion to the confidence score.

8. A method for training a classifier included in an apparatus for deep fake image discrimination, the method comprising:
generating a fake image by self-replicating a real image;
generating a synthetic image by swapping a portion of the real image with the fake image; and
learning the classifier to determine a deep fake image based on the synthetic image.

9. The method of claim 8, wherein the classifier is trained based on the synthetic image received through a gradient reversal layer.

10. The method of claim 9, wherein the fake image is generated through an autoencoder trained to generate a fake image by self-replicating a real image; and
the synthetic image is generated through an adaptive augmenter configured to generate a synthetic image by swapping a portion of the real image with the fake image based on a predetermined parameter.

11. The method of claim 10, wherein the autoencoder receives a reversed gradient from the gradient reversal layer, and is updated in a direction in which it is difficult for the classifier to determine a deep fake image.

12. The method of claim 10, wherein the predetermined parameter is composed of a combination of set values for at least one of a size, shape, number, and position of a mask for masking a portion of an image to be swapped.

13. The method of claim 12, wherein the classifier is configured to calculates a confidence score for each of one or more synthetic images generated according to one or more predetermined parameters having different set values and transmits the calculated confidence score to the adaptive augmenter; and
the adaptive augmenter is configured to decide a frequency of application of each of the one or more predetermined parameters based on the confidence score.

14. The method of claim 13, wherein the frequency of application of each of the one or more predetermined parameters is decided in reverse proportion to the confidence score.
